(19) United States
(12) Patent Application Publication
(10) Pub. No.: US 2025/0040001 A1
(43) Pub. Date: Jan. 30, 2025

(54) OVER THE RANGE FRENCH DOOR MICROWAVE WITH TWO OVEN CAVITIES

(71) Applicant: Haier US Appliance Solutions, Inc., Wilmington, DE (US)

(72) Inventors: Mark Heimerdinger, Louisville, KY (US); Kevin Dennis Mazzella, Louisville, KY (US); James Lee Armstrong, Louisville, KY (US)

(21) Appl. No.: 18/359,546

(22) Filed: Jul. 26, 2023

(51) Int. Cl. H05B 6/64

(52) U.S. Cl. CPC H05B 6/6423; H05B 6/6414

(57) ABSTRACT

An over-the-range dual microwave oven includes a cabinet having a first exhaust vent opening, a second exhaust vent opening, and a cabinet exhaust vent. First and second microwave oven enclosures are laterally spaced and supported in the cabinet, each enclosure having a cavity intake vent and a cavity exhaust vent. A fan assembly is operable to discharge a flow of cooling air through one or both of the exhaust vent openings and operable to discharge one or both of the cooling flows with a flow of exhaust air through the cabinet exhaust vent.

### FIELD OF THE INVENTION

The present disclosure relates generally to over the range kitchen appliances. In particular, the present disclosure generally relates to dual over the range microwave ovens.

### BACKGROUND OF THE INVENTION

Built-in microwave ovens have become commonplace in household kitchens. Commonly, a microwave is built-in over a cooktop or range and includes a ventilation system to capture and redirect steam, smoke, airborne grease, or odors generated at the range. Microwaves configured in this arrangement are generally referred to as over-the-range (OTR) appliances.

Generally, microwave ovens include an air flow to cool electronic components and to remove moisture vapor in the microwave enclosure during heating or cooking of food items. Some known OTR systems exhaust the air flow into the room in which the built-in microwave is located, which may increase temperature and humidity in the room and introduce cooking odors into the room.

In some household kitchens, a second built-in microwave appliance may be useful. An additional built-in microwave typically requires additional space, often occupying an area useful for storage. Configuring a second microwave to occupy the same space as an OTR microwave appliance would provide the benefit of a second microwave appliance without occupying storage space.

Accordingly, improvements to OTR microwave appliance to address the above identified drawbacks are desirable.

### BRIEF DESCRIPTION OF THE INVENTION

Aspects and advantages of the invention will be set forth in part in the following description, may be apparent from the description, or may be learned through practice of the invention.

In one exemplary aspect, an over-the-range microwave is disclosed, the over-the-range microwave comprising a cabinet having a top panel vertically spaced above a bottom panel, the bottom panel defining a first exhaust vent opening, a first side panel laterally spaced from a second side panel, and a front panel transversely spaced from a back panel, the cabinet further defines a cabinet exhaust vent. A first microwave oven enclosure is supported in the cabinet, the first microwave oven enclosure defining a first cavity intake vent and a first cavity exhaust vent. A first exhaust duct extends between the first exhaust vent opening and the cabinet exhaust vent, and a cooling discharge duct fluidly coupling the first cavity exhaust vent and the first exhaust vent opening. A fan assembly comprises a first intake fan fluidly coupled to the first cavity intake vent and an exhaust fan fluidly coupled to the first exhaust duct, wherein the fan assembly is operable in a first cooling flow state where the first intake fan operates to discharge a first flow of cooling air through the first exhaust vent opening and in an exhaust flow state where the first intake fan and the exhaust fan operate to discharge the first flow of cooling air and a first flow of exhaust air through the cabinet exhaust vent.

In another exemplary aspect, an over-the-range dual microwave oven is disclosed, the over-the-range dual microwave oven comprising a cabinet having a top panel vertically spaced above a bottom panel, the bottom panel defining a first exhaust vent opening and a second exhaust vent opening, a first side panel laterally spaced from a second side panel, and a front panel transversely spaced from a back panel, the cabinet further defining a cabinet exhaust vent, a first microwave oven enclosure supported in the cabinet, the first microwave oven enclosure defining a first cavity intake vent and a first cavity exhaust vent. A second microwave oven enclosure is supported in the cabinet laterally spaced from the first microwave oven enclosure, the second microwave oven enclosure defining a second cavity intake vent and a second cavity exhaust vent. A first exhaust duct extends between the first exhaust vent opening and the cabinet exhaust vent and a second exhaust duct extending between the second exhaust vent opening and the cabinet exhaust vent, a cooling discharge duct fluidly couples the first cavity exhaust vent, the second cavity exhaust vent, the first exhaust vent opening, and the second exhaust vent opening. A fan assembly comprises a first intake fan fluidly coupled to the first cavity intake vent, a second intake fan fluidly coupled to the second cavity intake vent, and an exhaust fan fluidly coupled to the first exhaust duct and the second exhaust duct. The first intake fan is operable to discharge a first flow of cooling air through the first exhaust vent opening in a first cooling flow state, the second intake fan is operable to discharge a second flow of cooling air through the second exhaust vent opening in a second cooling flow state, and the exhaust fan is operable to discharge one or more of the first flow of cooling air and the second flow of cooling air with a flow of exhaust air through the cabinet exhaust vent in an exhaust flow state.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of a kitchen appliance system with an over-the range microwave in accordance with an embodiment of the present disclosure;

FIG. 2 is a partial view the kitchen appliance system of FIG. 1 with an alternate over-the-range microwave in accordance with an embodiment of the present invention;

FIG. 3 represents a front view of a microwave appliance in accordance with an embodiment of the present disclosure;

FIG. 4 provides a rear partial sectional view of the microwave appliance of FIG. 3;

FIG. 5 provides a top partial sectional view of the microwave appliance of FIG. 3;

FIG. 6 represents a front bottom perspective view, in partial section, of a microwave appliance in accordance with an embodiment of the present disclosure;

FIG. 7 is a rear partial sectional view of the microwave appliance of FIG. 6; and

FIG. 8 is a front top perspective view, in partial section, of the microwave appliance of FIG. 6

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

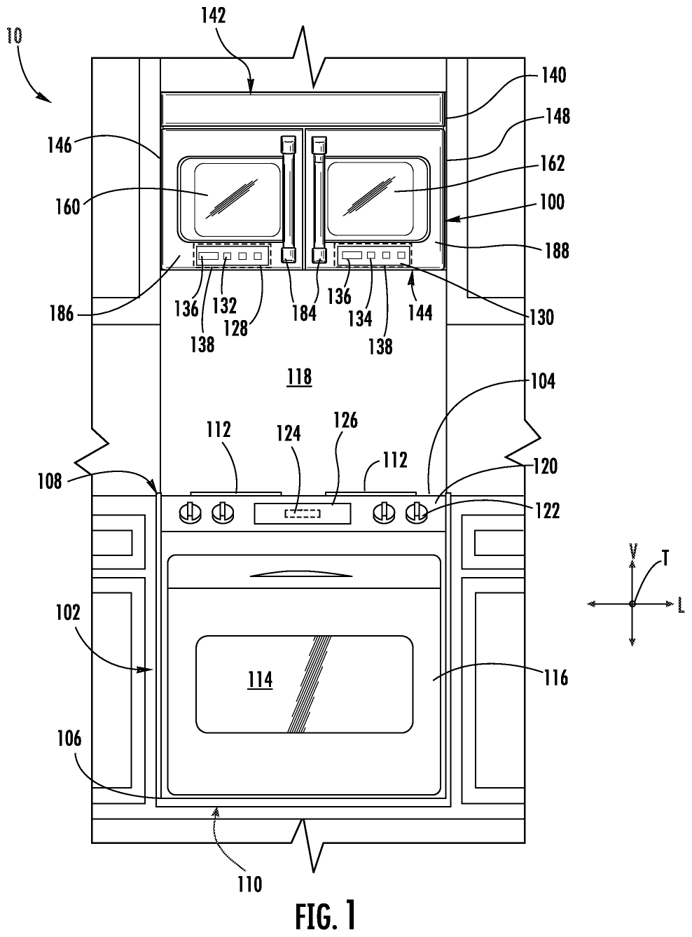

Turning to the figures, FIG. 1 provides a front view of kitchen appliance system 10 including an over-the-range microwave appliance 100 in accordance with the present disclosure. System 10 generally includes an over-the-range (OTR) microwave appliance 100 that can be positioned or mounted above a cooktop appliance 102. Each of these appliances 100, 102 within system 10 will be described independently and collectively below. However, it should be appreciated that the present subject matter is not limited to the specific appliances disclosed, and the specific appliance configurations are not intended to limit the scope of the present subject matter in any manner.

As shown in FIG. 1, system 10 defines a vertical direction V, a lateral direction L, and a transverse direction T. The vertical, lateral, and transverse directions are mutually perpendicular and form an orthogonal direction system. As used herein, this coordinate system applies equally to both the OTR microwave appliance 100 and cooktop appliance 102 and will thus be used interchangeably to describe both appliances and their positions relative to each other.

Cooktop appliance 102 can include a chassis or cabinet 106 that extends along the vertical direction V between a top portion 108 and a bottom portion 110, along the lateral direction L between a left side portion and a right side portion; and along the traverse direction T between a front portion and a rear portion. Cooktop appliance 102 includes a cooktop surface 104 having one or more heating elements 112 for use in, for example, heating or cooking operations. In exemplary embodiments, cooktop surface 104 is constructed with ceramic glass. In other embodiments, however, cooktop surface 104 may include another suitable material, such as a metallic material (e.g., steel) or another suitable non-metallic material. Heating elements 112 may be various sizes and may employ any suitable method for heating or cooking an object, such as a cooking utensil (not shown), and its contents. In some embodiments, for example, heating element 112 uses a heat transfer method, such as electric coils or gas burners, to heat the cooking utensil. In other embodiments, however, heating element 112 uses an induction heating method to heat the cooking utensil directly. In turn, heating element 112 may include a gas burner element, resistive heat element, radiant heat element, induction element, or another suitable heating element.

In some embodiments, cooktop appliance 102 includes an insulated cabinet 106 that defines a cooking chamber 114 selectively covered by one or more doors 116, 188 (two shown). One or more heating elements (not shown) may be enclosed within cabinet 110 to heat cooking chamber 114. Heating elements within cooking chamber 114 may be provided as any suitable element for cooking the contents of cooking chamber 114, such as an electric resistive heating element, a gas burner, a microwave element, a halogen element, etc. Thus, cooktop appliance 102 may be referred to as an oven range appliance. As will be understood by those skilled in the art, cooktop appliance 102 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated in figures are not intended to limit the present subject matter to any particular cooking chamber or heating element configuration, except as otherwise indicated.

As illustrated in FIG. 1, a user interface panel 120 may be provided on cooktop appliance 102. Although shown at front portion of cooktop appliance 102, another suitable location or structure (e.g., a backsplash) for supporting user interface panel 120 may be provided in alternative embodiments. In some embodiments, user interface panel 120 includes input components or controls 122, such as one or more of a variety of electrical, mechanical, or electro-mechanical input devices. Controls 122 may include, for example, rotary dials, knobs, push buttons, and touch pads. A controller 124 is in communication with user interface panel 120 and controls 122 through which a user may select various operational features and modes and monitor progress of cooktop appliance 102. In additional or alternative embodiments, user interface panel 120 includes a display component 126, such as a digital or analog display in communication with a controller 124 and configured to provide operational feedback to a user. In certain embodiments, user interface panel 120 represents a general purpose I/O (“GPIO”) device or functional block.

As shown, controller 124 is communicatively coupled (i.e., in operative communication) with user interface panel 120, controls 122, and display 126. Controller 124 may also be communicatively coupled with various operational components of cooktop appliance 102 as well, such as cooking chamber heating elements (not shown), sensors, etc. Input/output (“I/O”) signals may be routed between controller 124 and the various operational components of cooktop appliance 102. Thus, controller 124 can selectively activate and operate these various components. Various components of cooktop appliance 102 are communicatively coupled with controller 124 via one or more communication lines such as, for example, conductive signal lines, shared communication busses, or wireless communications bands.

In some embodiments, controller 124 includes one or more memory devices and one or more processors. The processors can be any combination of general or special purpose processors, CPUs, or the like that can execute programming instructions or control code associated with operation of cooktop appliance 102. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 124 may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 124 includes a network interface such that controller 124 can connect to and communicate over one or more networks with one or more network nodes. Controller 124 may also include one or more transmitting, receiving, or transceiving components for transmitting/receiving communications with other devices communicatively coupled with cooktop appliance 102. Additionally, or alternatively, one or more transmitting, receiving, or transceiving components can be located off board controller 124. Generally, controller 124 can be positioned in any suitable location throughout cooktop appliance 102. For example, controller 124 may be located proximate user interface panel 120 toward front portion of cooktop appliance 102. In optional embodiments, controller 124 is in operable communication with one or more microwave controllers of microwave appliance 100 (e.g., through one or more wired or wireless channels).

As noted above, microwave appliance 100 may be positioned or mounted above cooktop appliance 102 (e.g., as an OTR microwave). Specifically, an insulated cabinet or cabinet 140 of microwave oven or appliance 100 may be positioned above cooktop appliance 102 along the vertical direction V. As shown, cabinet 140 of microwave appliance 100 includes a plurality of outer walls and when assembled, microwave appliance 100 generally extends along the vertical direction V between a top end 142 and a bottom end 144; along the lateral direction L between a first side panel 146 and a second side panel 148; and along the transverse direction T between a front panel 150 and a rear panel 152 (FIG. 4). In some embodiments, cabinet 140 is spaced apart from cooktop surface 104 along the vertical direction V. An open region 118 may thus be defined along the vertical direction V between cooktop surface 104 and bottom end 144 of cabinet 140. Although a generally rectangular shape is illustrated, any suitable shape or style may be adapted to form the structure of cabinet 140.

Microwave appliance 100 is generally configured to heat articles (e.g., food or beverages) within a cooking chamber, for example first or second microwave oven enclosures 160, 162, respectively, using electromagnetic radiation. Microwave appliance 100 may include various components which operate to produce electromagnetic radiation, as is generally understood. For example, microwave appliance 100 may include a first heating assembly 164 having a first magnetron 166, a first voltage transformer 168, and additional components such as a high voltage capacitor, and a high voltage diode, as is understood. The first transformer 168 may provide energy from a suitable energy source (such as an electrical outlet) to the first magnetron 166. The first magnetron 166 may convert the energy to electromagnetic radiation, specifically microwave radiation. Microwave radiation produced by the first magnetron 166 may be transmitted through a first waveguide 170 and a first mode stirrer 172 to first microwave oven enclosure 160. Although described above with respect to a first microwave oven enclosure and associated components, some embodiments include a second microwave enclosure 162, and associated components, such as a second heating assembly 174, a second magnetron 176, a second transformer 178, a second waveguide 180, and a second mode stirrer 182 located within a second electronics chamber 159.

The structure and intended function of microwave ovens or appliances are generally understood by those of ordinary skill in the art and are not described in further detail herein. According to alternative embodiments, microwave appliance 100 may include one or more heating elements, such as electric resistance heating elements, gas burners, other microwave heating elements, halogen heating elements, or suitable combinations thereof, which are positioned within cooking chamber 114 for heating cooking chamber 114 and food items positioned therein.

Referring again to FIG. 1, OTR microwave appliance 100 may include a first control panel 128 for first microwave enclosure 160 and a second control panel 130 for second microwave enclosure 162. As illustrated, the control panels 128, 130 are located on the respective doors 186, 188. in other embodiments, the control panels 128, 130 may be located elsewhere on the microwave enclosures 160, 162 or may be incorporated with the cooktop controls 122. First and second control panels 128, 130 may represent a general-purpose Input/Output (“GPIO”) device or functional block for microwave appliance 100. In some embodiments, first and second control panels 128, 130 may include or be in operative communication with first and second input devices 132, 134, such as one or more of a variety of digital, analog, electrical, mechanical, or electro-mechanical input devices including rotary dials, control knobs, push buttons, toggle switches, selector switches, and touch pads. Additionally, first and second control panels 128, 130 may each include a display 136, such as a digital or analog display device generally configured to provide visual feedback regarding the operation of microwave appliance 100. For example, display 136 may be provided on control panels 128, 130 and may include one or more status lights, screens, or visible indicators. According to exemplary embodiments, first and second user input devices 132, 134 and displays 136 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

First and second microwave oven enclosures 160, 162 may further include or be in operative communication with processing devices or a controller 138 that may be generally configured to facilitate appliance operation. For purposes of this discussion, first and second microwave oven enclosures 160, 162 include a controller 138. However, the first and second microwave oven enclosures 160, 162 may use a single controller 138 for operation of each microwave enclosure. in some embodiments, the first and second microwave oven enclosures 160, 162 may be operated by the cooktop controller 124. For ease of illustration and discussion, the illustrative embodiment of FIG. 1 includes one controller 138 for each microwave oven enclosure 160, 162.

Control panels 128, 130, first and second user input devices 132, 134, and displays 136 may be in communication with controllers 138 such that controllers 138 may receive control inputs from user input devices 132, 134, may display information using displays 136, and may otherwise regulate operation of microwave appliance 100. For example, signals generated by controllers 138 may operate appliance 100, including any or all system components, subsystems, or interconnected devices, in response to the position of user input devices 132, 134 and other control commands. Control panels 128, 130 and other components of appliance 100 may be in communication with controllers 138 via, for example, one or more signal lines or shared communication busses. In this manner, Input/Output (“I/O”) signals may be routed between controllers 138 and various operational components of appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controllers 138 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controllers 138 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controllers 138 may be operable to execute programming instructions or micro-control code associated with an operating cycle of appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controllers 138 as disclosed herein is capable of and may be operable to perform any methods, method steps, or portions of methods as disclosed herein. For example, in some embodiments, methods disclosed herein may be embodied in programming instructions stored in the memory and executed by controllers 138.

The memory devices may also store data that can be retrieved, manipulated, created, or stored by the one or more processors or portions of controllers 138. The data can include, for instance, data to facilitate performance of methods described herein. The data can be stored locally (e.g., on controllers 138) in one or more databases and/or may be split up so that the data is stored in multiple locations. In addition, or alternatively, the one or more database(s) can be connected to controllers 138 through any suitable network(s), such as through a high bandwidth local area network (LAN) or wide area network (WAN). In this regard, for example, controllers 138 may further include a communication module or interface that may be used to communicate with one or more other component(s) of appliance 100, controllers 138, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

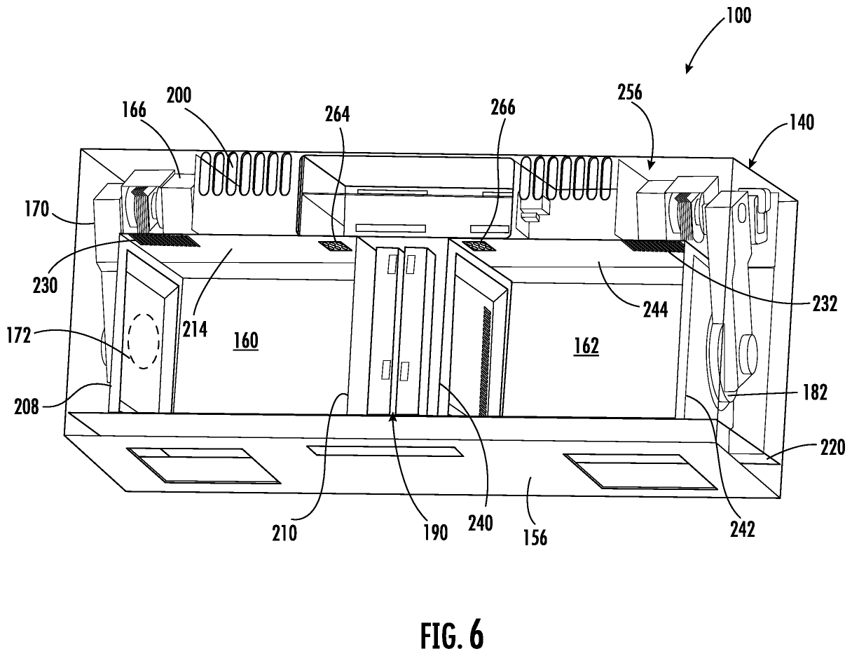

FIG. 1 is illustrative of a microwave appliance 100 fitted with a first door 186 and a second door 188, each supported for rotation at a first end. For example, OTR microwave appliance 100 includes first door 186 movably mounted (i.e., rotatably attached) to microwave cabinet 140 at a first side panel 146 to permit selective access to the first microwave oven enclosure 160. Similarly, second door 188 is movably mounted to microwave cabinet 140 at a second side panel 148 to permit selective access to second microwave oven enclosure 162. Generally, the doors 186, 188 can move between an open position (not shown) and a closed position (e.g., FIG. 1) in which the microwave oven enclosures 160, 162 are enclosed. The open position permits access to the first and second microwave oven enclosures 160, 162. A handle 184 may be mounted to or formed on the first and second doors 186, 188 to facilitate opening and closing of the doors. A mullion 190 (FIG. 6) may be provided at the front panel 150 of the cabinet to facilitate sealing and mechanical latching for the second end of first and second doors 186, 188 when in the closed position. In the closed position, the second end of the first and second doors 186, 188 engages a portion of the mullion 190 to enclose the microwave oven enclosures 160, 162. When first and second doors 186, 188 are configured as illustrated in FIG. 1, the door arrangement is sometimes referred to as a “French door” configuration.

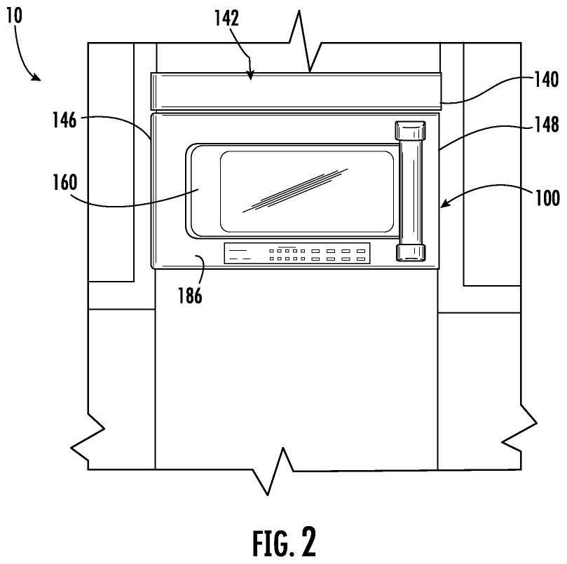

In some embodiments, for example the illustrative embodiment of FIG. 2, only one door, first door 186, and only one microwave oven enclosure 160 are provided for the OTR microwave appliance 100. The embodiment of FIG. 2 is rotatably mounted to the first side panel 146 of cabinet 140. In other embodiments, the first door 186 may be rotatably mounted to the second side panel 148. Sealing and latching are facilitated at the side of the door opposite the rotatable attachment. The first door 186 functions as described above, selectively movable between an open position (not shown) and a closed position as illustrated in FIG. 2. In the open position, access is provided to the first microwave oven enclosure 160 and in the closed position access is prevented.

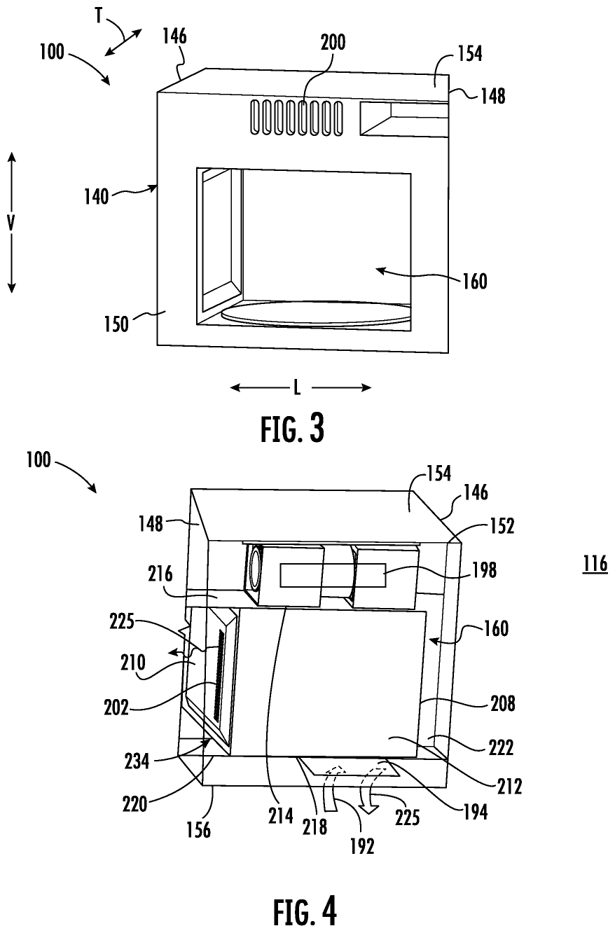

FIG. 3 represents a front view of an OTR microwave appliance 100 in accordance with an embodiment of the present invention with one microwave oven enclosure 160. For clarity, the first microwave oven appliance door 186 is not included in the figure. FIG. 4 represents a rear view of the OTR microwave appliance of FIG. 3.

As illustrated, microwave cabinet 140 includes first side panel 146 laterally spaced from second side panel 148. The cabinet 140 further includes a front panel 150 transversely spaced from the back panel 152, and a top panel 154 laterally spaced above the bottom panel 156. The bottom panel defines a first exhaust vent opening 194 illustrated as a rectangular opening in the illustrative embodiment of FIG. 4. In other embodiments, the first exhaust vent opening 194 may have other shapes. The cabinet further defines a cabinet exhaust vent formed in one of the panels. For ease of illustration, cabinet exhaust vent 198 is shown in FIG. 4 as defined by the back panel 152. In other embodiments, the cabinet exhaust vent may be formed in another panel forming microwave cabinet 140.

A first microwave oven enclosure 160 is supported in the microwave cabinet 140 and defines a first cavity intake vent 200 and a first cavity exhaust vent 202. The first microwave oven enclosure 160 comprises a first side wall 208 laterally spaced from the second side wall 210, and a back wall 212. An upper wall 216 extends between the first side panel 146 and the second side panel 148 and provides a top wall 214 to the first microwave oven enclosure 160. The top wall 214 is spaced vertically below the top panel 154. A lower wall 220 extends between the first side panel 146 and the second side panel 148 and provides a bottom wall 218 to the first microwave oven enclosure 160. In addition to forming the top wall 214 and bottom wall 218, the upper wall 216 and lower wall 220 may cooperate to support the first microwave oven enclosure 160 in cabinet 140.

An exhaust duct may be formed within cabinet 140 to provide an exhaust path for flows of exhaust air, which may include cooling air in some embodiments. In the illustrative embodiment of FIG. 4 first exhaust duct 222 extends from the first exhaust vent opening 194 to the cabinet exhaust vent 198. The first exhaust duct as illustrated may be formed in part by the bottom panel 156, the first side panel 146, the first side wall 208, the top panel 154, and the back panel 152. The cabinet exhaust vent 198 may be coupled to an external atmosphere 116, which may be the atmosphere of the room in which the microwave cabinet 140 is located or may be the outdoor atmosphere.

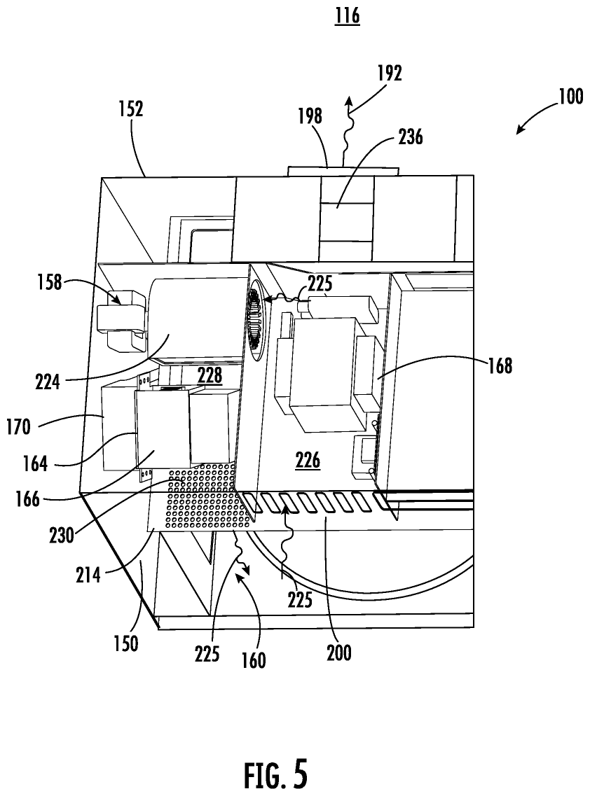

FIG. 5 provides a top perspective view of the first microwave cabinet 140 with the first microwave oven enclosure 160 supported therein. For clarity, top panel 154 of cabinet 140 is not shown. In the illustrative representation of FIG. 5, first intake fan 224 is located vertically above the first microwave oven enclosure 160 and in fluid communication with the first cavity intake vent 200. In the embodiment illustrated, the first intake fan 224 draws a flow of air, for example a first flow of cooling air 225, in through the first cavity intake vent 200 into first magnetron compartment 226 to provide a cooling flow for the first magnetron 166 and other components in the first magnetron compartment. The first intake fan 224 also urges the first flow of cooling air 225 from the magnetron compartment 226 to the transformer compartment 228.

As illustrated in FIG. 5, the first transformer compartment 228 may be in fluid communication with the first microwave oven enclosure 160 through a first cavity air inlet 230 formed in the top wall 214 of the microwave oven enclosure 160. The first cavity air inlet 230 is illustrated as a series of perforations or holes formed in the top wall 214 for ease of illustration only. In accordance with other embodiments, the first cavity air inlet 230 may have other configurations, for example one or more louvers or a series of slots to provide fluid communication between the transformer compartment 228 and the microwave oven enclosure 160. The first flow of cooling air 225 may be urged, for example by first intake fan 224, to flow out of transformer compartment 228 and into the first microwave oven enclosure 160 through the first cavity air inlet 230.

In operation, the first door 186, or first and second doors 186, 188 are typically in a closed position (FIGS. 1 and 2) for generally recognized safe practice. With the door(s) closed, the first flow of cooling air 225 into the transformer chamber 228 is urged into the first microwave oven enclosure 160 through the first cavity air inlet 230 and exits the first microwave oven enclosure 160 through the first cavity exhaust vent 202. The first cavity exhaust vent 202 may be in fluid communication with a cooling discharge duct 234 disposed adjacent to the second side wall 210 which couples the first cavity exhaust vent 202 to the first exhaust vent opening 194.

As illustrated in the exemplary embodiment of FIGS. 4 and 5, first intake fan 224 is fluidly coupled to the first cavity intake vent 200, at least through the first magnetron compartment 226. First exhaust duct 222 is fluidly coupled to exhaust fan 236, which may be fluidly coupled to cabinet exhaust vent 198. The first intake fan 224, the first cavity intake vent 200, the exhaust fan 236, and the first exhaust duct 222 cooperate and comprise a first fan assembly operable to urge one or more flows of air, for example cooling air or exhaust air. In a first cooling flow state of the first fan assembly, the first intake fan 224 operates to draw in cooling air through the first cavity intake vent 200 and discharge the first flow of cooling air 225 through the first exhaust vent opening 194. The first fan assembly is alternately operable in an exhaust flow state in which the first intake fan 224 and the exhaust fan 236 operate to discharge the first flow of cooling air 225 and a first flow of exhaust air 192 through the cabinet exhaust vent. In the exhaust flow state, exhaust fan 236 operates to urge a first flow of exhaust air 192 into a first exhaust flow path including the first exhaust vent opening 194, through the first exhaust duct 222 formed adjacent to first side wall 208, leading to exhaust fan 236 and cabinet exhaust vent 198. The cabinet exhaust vent 198 may be coupled to In some embodiments, the first flow of exhaust air 192 may include the first flow of cooling air 225.

The cabinet 140 and first microwave oven enclosure 160 cooperate to form a series of passages or ducts to direct air flows, for example the first cooling air flow 225 and exhaust air 192. As illustrated, the first exhaust duct 222 is at least partially defined by the first side panel 146 of cabinet 140 and the first side wall 208 of the microwave oven enclosure 160. Cooling discharge duct 234 is generally vertically aligned adjacent to the second side wall 210 and at least partially defined in the exemplary embodiment of FIG. 4 by the second side wall 210, the second side panel 148, the upper wall 216, and the lower wall 220. In other embodiments, one or more defining structures of the discharge duct may be replaced with other structures.

As illustrated for example in FIG. 5, first electronics chamber 158 may be located above first microwave oven enclosure 160, vertically between the upper wall 216 and top panel 154 and transversely bounded by the first cavity intake vent 200 of the front panel 150 and the back panel 152. The first electronics chamber 158 comprises the first magnetron compartment 226 and the first transformer compartment 228, with the first intake fan 224 fluidly coupling the first magnetron compartment 226 and the first transformer compartment 228. First cavity air inlet 230 provides fluid communication between the first electronics chamber 158, specifically the first transformer compartment 228, and the first microwave oven enclosure 160. The first intake fan 224 is operative in a first cooling flow state to draw in a flow of cooling air 225 through the first cavity intake vent 200, through the first electronics chamber 158 (i.e., through the first magnetron compartment 226 and first transformer compartment 228) and into the first microwave oven enclosure 160 through the first cavity inlet vent 230.

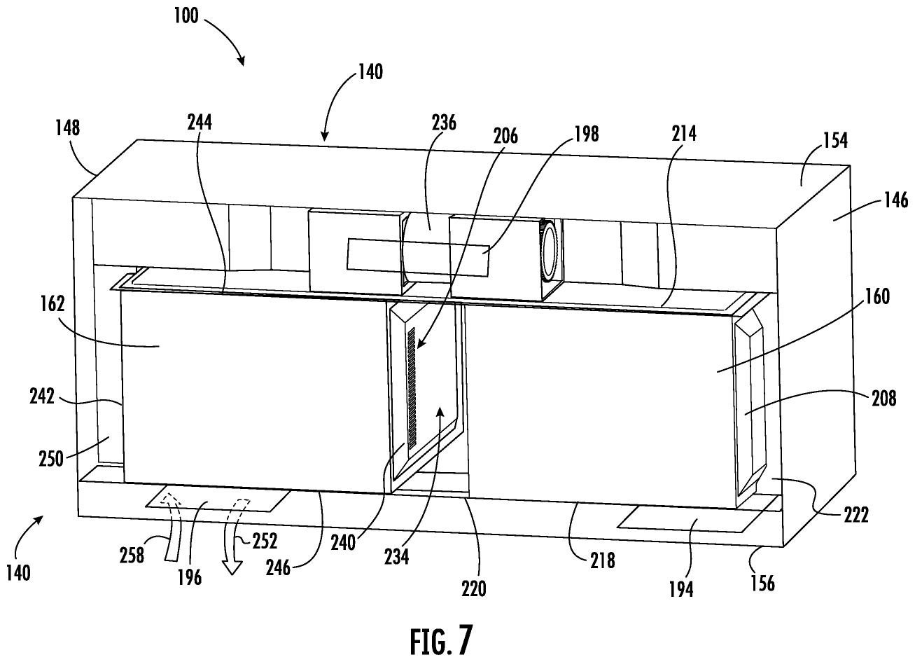

According to an embodiment, the OTR microwave appliance 100 may include a second microwave oven enclosure 162 supported in the cabinet 140 laterally spaced from the first microwave oven enclosure 160 as illustrated in FIGS. 6 and 7. FIG. 6 is a front view (with front panel 150 removed for clarity) of a microwave appliance 100 comprising of two microwave oven enclosures 160, 162 supported within cabinet 140. FIG. 7 is a rear view of the microwave appliance 100 of FIG. 6 with the back panel 152 removed for illustration. This configuration, with two microwave oven enclosures 160, 162, may be referred to as an OTR dual microwave appliance. The second microwave oven enclosure 162 comprises third side wall 240 and laterally fourth side wall 242. As illustrated, third side wall 240 is spaced from second side wall 210 and cooperates with second side wall 210 to at least partially define cooling discharge duct 234. Fourth side wall 242 is laterally spaced from second side panel 148. Second exhaust duct 250 is at least partially defined by fourth side wall 242, second side panel 148, lower wall 220, upper wall 216, and top panel 154.

Upper wall 216 extends from first side panel 146 to second side panel 148 and forms top wall 244 of second microwave oven enclosure 162. Similarly, lower wall 220 extends from first side panel 146 to second side panel 148 and forms bottom wall 246 of second microwave oven enclosure 162. As with the first microwave oven enclosure 160, upper wall 216 and lower wall 220 may facilitate support for the second microwave oven enclosure 162 in cabinet 140. Further, bottom panel 156 may define a second exhaust vent opening 196. For clarity, the OTR microwave appliance 100 with dual microwave oven enclosures 160, 162 is shown and described with similarly formed and located first and second exhaust vent openings 194, 196. It should be appreciated that in some embodiments, one exhaust vent opening is provided, either first or second exhaust vent opening 194 or 196, and the single exhaust vent opening may be defined by the bottom panel at a location between the first and second side panels 146, 148. In embodiments with one exhaust vent opening, exhaust ducts 222, 250 (discussed below) extend from the single exhaust vent opening to the cabinet exhaust vent 198 as described.

A second exhaust duct may be formed within cabinet 140 adjacent to second microwave oven enclosure 162 to provide an exhaust path for flows of exhaust air, which may include cooling air in some embodiments. In the illustrative embodiment of FIG. 7 second exhaust duct 250 extends from the second exhaust vent opening 196 to the cabinet exhaust vent 198. The first exhaust duct as illustrated may be formed in part by the bottom panel 156, the first side panel 146, the first side wall 208, the top panel 154, and the back panel 152. The cabinet exhaust vent 198 may be coupled to an external atmosphere 116, which may be the atmosphere of the room in which the microwave cabinet 140 is located or may be the outdoor atmosphere.

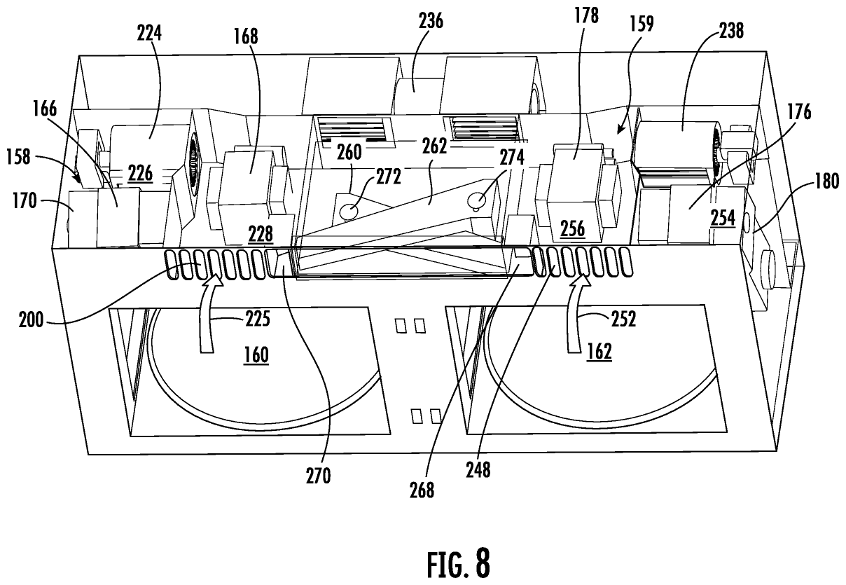

FIG. 8 provides a top perspective view of the microwave cabinet 140 with first and second microwave oven enclosures 160, 162 supported therein. For clarity, top panel 154 of cabinet 140 is not shown. In the illustrative representation of FIG. 8, first intake fan 224 is positioned and operates as discussed above. Second intake fan 238 is located vertically above the second microwave oven enclosure 162 and in fluid communication with the second cavity intake vent 248. In the embodiment illustrated, the second intake fan 238 draws a flow of air, for example a second flow of cooling air 252, in through the second cavity intake vent 248 into second magnetron compartment 254 to provide a cooling flow for the second magnetron 176 and other components in the second magnetron compartment 254. The second intake fan 238 fluidly couples the second magnetron compartment 254 to the second transformer compartment 256 and urges the second flow of cooling air 252 from the second magnetron compartment 254 to the second transformer compartment 256.

The second flow of cooling air 252 into the second transformer chamber 254 is urged into the second microwave oven enclosure 162 through the second cavity air inlet 232 and exits the second microwave oven enclosure 162 through the second cavity exhaust vent 206 formed in third side wall 240. The second cavity exhaust vent 206 may be in fluid communication with cooling discharge duct 234 disposed between the first and second microwave oven enclosures 160, 162 and at least partially defined by second side wall 210 and third side wall 240. In an embodiment, the cooling discharge duct fluidly couples the second cavity exhaust vent 206 to the second exhaust vent opening 196. In other embodiments, a single exhaust vent opening is provided to which the second cavity exhaust vent 206 may be fluidly coupled.

As illustrated in the exemplary embodiment of FIGS. 6, 7, and 8, second intake fan 238 is fluidly coupled to the second cavity intake vent 248, at least through the second magnetron compartment 254. Second exhaust duct 250 is fluidly coupled to exhaust fan 236, which may be fluidly coupled to cabinet exhaust vent 198. The second intake fan 238, the second cavity intake vent 248, the exhaust fan 236, and the second exhaust duct 250 cooperate with the first intake fan 224, the first cavity intake vent 200, and the first exhaust duct 222 to comprise a second fan assembly operable to urge one or more flows of air, for example cooling air or exhaust air. In a second cooling flow state of the second fan assembly, the first intake fan 224 operates to draw in cooling air through the first cavity intake vent 200 and discharge the first flow of cooling air 225 through the first exhaust vent opening 194 and the second intake fan 238 operates to draw in cooling air through the second cavity intake vent 248 and discharge the second flow of cooling air 252 through the second exhaust vent opening 196.

The fan assembly in a dual microwave appliance is alternately operable in a second exhaust flow state in which the first intake fan 224, the second intake fan 238, and the exhaust fan 236 operate to discharge the first flow of cooling air 225, the second flow of cooling air 252, a first flow of exhaust air 192, and a second flow of exhaust air 258 through the cabinet exhaust vent 198. In the second exhaust flow state, exhaust fan 236 operates to urge a first flow of exhaust air 192 into a first exhaust flow path including the first exhaust vent opening 194, the first exhaust duct 222, the exhaust fan 236, and cabinet exhaust vent 198. In the second exhaust flow state, exhaust fan 236 further operates to urge a second flow of exhaust air 258 into a second exhaust flow path including the second exhaust vent opening 196, the second exhaust duct 250, the exhaust fan 236, and cabinet exhaust vent 198. In some embodiments, the first flow of exhaust air 192 and the second flow of exhaust air 258 may include the first flow of cooling air 225 and the second flow of cooling air 252. The cabinet exhaust vent 198 may be coupled to an external atmosphere 116, which may be the atmosphere of the room in which the microwave cabinet 140 is located or may be the outdoor atmosphere.

As illustrated in FIG. 6, the second transformer compartment 256 may be in fluid communication with the second microwave oven enclosure 162 through a second cavity air inlet 232 formed in the top wall 244 of the second microwave oven enclosure 162. The second cavity air inlet 232 is illustrated as a series of perforations or holes formed in the top wall 244 for ease of illustration only. In accordance with other embodiments, the second cavity air inlet 232 may have other configurations, for example one or more louvers or a series of slots to provide fluid communication between the second transformer compartment 256 and the second microwave oven enclosure 162. The second flow of cooling air 252 may be urged, for example by second intake fan 238, to flow out of second transformer compartment 256 and into the second microwave oven enclosure 162 through the second cavity air inlet 232.

As illustrated in the embodiment of FIG. 8, first and second microwave oven enclosures 160, 162 include first and second sensor ducts 260, 262, respectively, in fluid communication with the enclosures. In some embodiments, the first and second sensor ducts 260, 262 receive a portion of the cooling flows 225, 252 from the respective microwave oven enclosures 160, 162. First sensor duct 260 is fluidly coupled to first microwave oven enclosure 160 via first sensor inlet vent 264 defined in the top wall 214. The first sensor duct 260 extends to the first sensor duct exhaust 268 defined in the front panel 150 vertically above the second microwave oven enclosure 162. The first sensor duct 260 receives a portion of the cooling air flow 225 and diverts the portion to first sensor duct exhaust 268. First sensor 272, for example a humidity sensor, is disposed within the first sensor duct 260 and subject to a portion of the first cooling air flow 225. First sensor 272 may be in operative communication with controller 138 to provide signals related to the atmosphere in the first microwave oven enclosure 160 which may influence control the first heating assembly 164.

Second sensor duct 262 is fluidly coupled to first microwave oven enclosure 160 via first sensor inlet vent 264 defined in the top wall 214. The first sensor duct 260 extends to the first sensor outlet defined in the front panel 150 vertically above the second microwave oven enclosure 162. The second sensor duct 262 extends to the second sensor duct exhaust 270 defined in the front panel 150 vertically above the first microwave oven enclosure 160. The second sensor duct 262 receives a portion of the cooling air flow 252 and diverts the portion to second sensor duct exhaust 270. Second sensor 274, for example a humidity sensor, is disposed within the second sensor duct 262 and subject to a portion of the second cooling air flow 252. Second sensor 274 may be in operative communication with controller 138 to provide signals related to the atmosphere in the second microwave oven enclosure 162 which may influence control the second heating assembly 174.

In some embodiments, the first and second sensor duct exhausts 268, 270 are separated from the second and first cavity intake vents 248, 200, respectively, by separators, which may be walls or diverters to direct the flow of sensor air away from the intake vents 200, 248.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An over-the-range microwave defining a vertical direction, a lateral direction, and a transverse direction, the over-the-range microwave comprising:
a cabinet having a top panel vertically spaced above a bottom panel, the bottom panel defining a first exhaust vent opening, a first side panel laterally spaced from a second side panel, and a front panel transversely spaced from a back panel, the cabinet further defining a cabinet exhaust vent;
a first microwave oven enclosure supported in the cabinet, the first microwave oven enclosure defining a first cavity intake vent and a first cavity exhaust vent;
a first exhaust duct extending between the first exhaust vent opening and the cabinet exhaust vent;
a cooling discharge duct fluidly coupling the first cavity exhaust vent and the first exhaust vent opening; and
a fan assembly comprising a first intake fan fluidly coupled to the first cavity intake vent and an exhaust fan fluidly coupled to the first exhaust duct, wherein the fan assembly is operable in a first cooling flow state where the first intake fan operates to discharge a first flow of cooling air through the first exhaust vent opening and in an exhaust flow state where the first intake fan and the exhaust fan operate to discharge the first flow of cooling air and a first flow of exhaust air through the cabinet exhaust vent.

2. The over-the-range microwave of claim 1, wherein the first microwave oven enclosure comprises:
a first side wall laterally spaced from the first side panel;
a second side wall laterally spaced from the first side wall, the second side wall defining the first cavity exhaust vent;
an upper wall extending laterally from the first side panel to the second side panel and spaced vertically below the top panel, the upper wall forming a top wall of the first microwave oven enclosure; and
a lower wall extending laterally from the first side panel to the second side panel and spaced vertically above the bottom panel, the lower wall forming a bottom wall of the first microwave oven enclosure; and
wherein the first exhaust duct is partially defined by the first side panel and the first side wall; and the cooling discharge duct is partially defined by the second side wall and the second side panel.

3. The over-the-range microwave of claim 1, wherein the first intake fan urges the first flow of cooling air through a first electronics chamber and the first microwave oven enclosure; and
wherein the first electronics chamber comprises:
a first transformer compartment positioned vertically above the first microwave oven enclosure;
a first cavity air inlet; and
a first magnetron compartment positioned vertically above the first microwave oven enclosure; and
wherein the first intake fan fluidly couples the first transformer compartment and the first magnetron compartment.

4. The over-the-range microwave of claim 1, wherein the fan assembly operating in the exhaust flow state urges the first flow of exhaust air into the cabinet through the first exhaust vent opening.

5. The over-the-range microwave of claim 4, wherein the exhaust fan urges the first flow of exhaust air through an exhaust flow path comprising the first exhaust vent opening, the first exhaust duct, and the cabinet exhaust vent.

6. The over-the-range microwave of claim 5, wherein the cabinet exhaust vent is fluidly coupled to an external atmosphere.

7. The over-the-range microwave of claim 2, further comprising:
a second microwave oven enclosure supported in the cabinet laterally spaced from the first microwave oven enclosure, the second microwave oven enclosure defining a second cavity intake vent and a second cavity exhaust vent.

8. The over-the-range microwave of claim 7, wherein the cooling discharge duct is fluidly coupled to the second cavity exhaust vent.

9. The over-the-range microwave of claim 8, wherein the cabinet further defines a second exhaust vent opening.

10. The over-the-range microwave of claim 9 wherein the cooling discharge duct is fluidly coupled to the second exhaust vent opening.

11. The over-the-range microwave of claim 9, further comprising a second exhaust duct extending between the second exhaust vent opening and the cabinet exhaust vent.

12. The over-the-range microwave of claim 11 wherein:
the fan assembly further comprises a second intake fan fluidly coupled to the second cavity intake vent;
the exhaust fan is fluidly coupled to the second exhaust duct; and
the fan assembly is operable in a second cooling flow state where the second intake fan operates to discharge a second flow of cooling air through the second exhaust vent opening and in a second exhaust flow state where the second intake fan and the exhaust fan operate to discharge the second flow of cooling air and a second flow of exhaust air through the cabinet exhaust vent.

13. The over-the-range microwave of claim 12, wherein the fan assembly operating in the second exhaust flow state urges the second flow of exhaust air into the cabinet through the second exhaust vent opening.

14. The over-the-range microwave of claim 12, wherein the second intake fan urges the second flow of cooling air through a second electronics chamber and the second microwave oven enclosure; and
wherein the second electronics chamber comprises:
a second transformer compartment positioned vertically above the second microwave oven enclosure;
a second magnetron compartment positioned vertically above the second microwave oven enclosure;
a second cavity air inlet; and
further wherein the second intake fan fluidly couples the second transformer compartment and the second magnetron compartment.

15. The over-the-range microwave of claim 11, wherein the second microwave oven enclosure comprises:
a third side wall laterally spaced from the second side wall;
a fourth side wall laterally spaced from the third side wall; and
wherein:
the upper wall forms a top wall of the second microwave oven enclosure;
the lower wall forms a bottom wall of the second microwave oven enclosure;
the second exhaust duct is partially defined by the second side panel and the fourth side wall; and
the cooling discharge duct is partially defined by the second side wall and the third side wall.

16. An over-the-range dual microwave oven defining a vertical direction, a lateral direction, and a transverse direction, the over-the-range dual microwave comprising:
a cabinet having a top panel vertically spaced above a bottom panel, the bottom panel defining a first exhaust vent opening and a second exhaust vent opening, a first side panel laterally spaced from a second side panel, and a front panel transversely spaced from a back panel, the cabinet further defining a cabinet exhaust vent;
a first microwave oven enclosure supported in the cabinet, the first microwave oven enclosure defining a first cavity intake vent and a first cavity exhaust vent;
a second microwave oven enclosure supported in the cabinet laterally spaced from the first microwave oven enclosure, the second microwave oven enclosure defining a second cavity intake vent and a second cavity exhaust vent;
a first exhaust duct extending between the first exhaust vent opening and the cabinet exhaust vent and a second exhaust duct extending between the second exhaust vent opening and the cabinet exhaust vent;
a cooling discharge duct fluidly coupling the first cavity exhaust vent, the second cavity exhaust vent, the first exhaust vent opening and the second exhaust vent opening;
a fan assembly comprising a first intake fan fluidly coupled to the first cavity intake vent, a second intake fan fluidly coupled to the second cavity intake vent, and an exhaust fan fluidly coupled to the first exhaust duct and the second exhaust duct, wherein the first intake fan is operable to discharge a first flow of cooling air through the first exhaust vent opening in a first cooling flow state, the second intake fan is operable to discharge a second flow of cooling air through the second exhaust vent opening in a second cooling flow state; and the exhaust fan is operable to discharge one or more of the first flow of cooling air and the second flow of cooling air with a flow of exhaust air through the cabinet exhaust vent in an exhaust flow state.

17. The over-the-range dual microwave of claim 16, further comprising:
a first sensor duct having a first end in fluid communication with the first microwave oven enclosure, a second end in fluid communication with an external atmosphere through a first sensor duct exhaust formed in the front panel vertically above the second microwave oven enclosure, and a first humidity sensor mounted within the first sensor duct; and
a second sensor duct having a first end in fluid communication with the second microwave oven enclosure, a second end in fluid communication with the external atmosphere through a second sensor duct exhaust formed in the front panel vertically above the first microwave oven enclosure, and a second humidity sensor mounted within the second sensor duct; and
wherein a portion of the first flow of cooling air is urged to flow through the first sensor duct in the first cooling flow state and a portion of the second flow of cooling air is urged to flow through the second sensor duct in the second cooling flow state.

18. The over-the-range dual microwave of claim 16, further comprising:
a first transformer positioned in a first transformer compartment above the first microwave oven enclosure;
a first magnetron positioned in a first magnetron compartment above the first microwave oven enclosure;
a first waveguide coupled to the first transformer;
a first mode stirrer coupled to the first waveguide and to the first microwave oven enclosure;
a second transformer positioned in a second transformer compartment above the second microwave oven enclosure;
a second magnetron positioned in a second magnetron compartment above the second microwave oven enclosure;
a second waveguide coupled to the second transformer;
a second mode stirrer coupled to the second waveguide and to the second microwave oven enclosure; and
wherein the first intake fan further urges the first flow of cooling air through the first transformer compartment and the first magnetron compartment, and the second intake fan further urges the second flow of cooling air through the second transformer compartment and the second magnetron compartment.

19. The over-the-range dual microwave of claim 18, wherein the first mode stirrer is coupled to a first side wall of the first microwave oven enclosure and the second mode stirrer is coupled to a fourth side wall of the second microwave oven enclosure.

20. The over-the-range dual microwave of claim 16, further comprising:
a mullion separating the first and second microwave oven enclosures at the front panel of the cabinet;
a first door comprising a first end rotatably mounted to the cabinet at a first side for rotation between a closed position in which the first door encloses the first microwave oven enclosure and a second end of the first door engages a portion of the mullion, and an open position; and
a second door comprising a first end rotatably mounted to the cabinet at a second side for rotation between a closed position in which the second door encloses the second microwave oven enclosure and a second end of the second door engages a portion of the mullion, and an open position.
